(19) United States
(12) Patent Application Publication
(10) Pub. No.: US 2026/0243974 A1
(43) Pub. Date: Aug. 20, 2026

(54) MICRO-OPTICAL COUPLER FOR PHOTONIC INTEGRATED CIRCUIT

(71) Applicant: UNIVERSITY COLLEGE CORK - NATIONAL UNIVERSITY OF IRELAND, CORK, Cork (IE)

(72) Inventor: Peter O'BRIEN, Belgooly, Cork (IE)

(21) Appl. No.: 19/469,828

(22) PCT Filed: Mar. 28, 2024
(86) PCT No.: PCT/EP2024/058724

§ 371 Date: Sep. 26, 2025

(30) Foreign Application Priority Data
Mar. 28, 2023 (GB) 2304528.9

(51) Int. Cl. G02B 6/42

(52) U.S. Cl. CPC G02B 6/4214

(57) ABSTRACT

Disclosed is a micro-optical coupling element that includes a wafer, an array of micro-lenses fabricated at one side of a wafer, and an array of discrete micro-prisms fabricated at another side of the wafer, wherein the array of micro-lenses is integrated with corresponding array of micro-prisms, such that each micro-prism is positioned directly in-line or aligned over corresponding micro-lens, wherein each micro-prism is configured to rotate an input optical beam by up to 90 degrees, and corresponding micro-lens is configured to expand and collimate the rotated beam, to form a pluggable optical connector.

### FIELD

The present disclosure relates to photonic integrated circuits, and more particularly to micro-optical components to couple light into and out of Photonic Integrated Circuits.

### BACKGROUND

Photonic Integrated Circuits (PICs) use a laser source to inject light that drives the components, similar to turning on a switch to inject electricity that drives electronic components. Using light instead of electricity, integrated photonic technology provides a solution to the limitations of electronics like integration and heat generation, taking devices to the next level, the so-called “more than Moore” concept to increase capacity and speed of data transmission. PICs offer advantages such as miniaturization, higher speed, low thermal effects, large integration capacity, and compatibility with existing processing flows that allow for high yield, volume manufacturing, and lower prices. Various applications for integrated photonics range from high-speed communications for data centres, sensors for automotive such as LIDAR, medical, and point-of-care diagnostics, and the growth of the Internet of Things (IoT).

The light is guided within the PIC device through a waveguide. The waveguide dimensions are typically on the order of a few microns. However, coupling light from a laser or optical fibre to the PIC waveguide is a major technical challenge due to the demanding alignment tolerances. FIG. 1 illustrates fibre optics edge coupling, in that the glass fibre is usually aligned to the waveguide at the edge of the PIC chip and bonded to the chip using a clear UV cured epoxy resin. The epoxies are convenient but not reliable and are prone to shift over time, which affect the precision alignment of the optical fibre to the PIC waveguide. Also, optical fibres in an array form and their fixed or bonded configuration have relatively high cost. The fixed configuration may not be ideal for many applications, such as medical devices, where a pluggable or removable connector is desirable. FIG. 2 illustrates using micro-optics to achieve the pluggability, where a micro-lens may be bonded to the PIC chip and an expanded and collimated beam may be formed. This collimated beam may be refocused into a receiving fibre. This avoids the need to bond optical fibres directly to the PIC chip. FIG. 3 illustrates an air gap formed by the collimated beam between the fibre used for the pluggable connector.

However, edge coupling limits the number of optical channels that can be connected in a 2D form. Also, edge coupling provides relatively slower packaging times as the PIC edge is less visible to a packaging machine.

### SUMMARY

In an aspect of the present invention, as set out in the appended claims, there is provided a micro-optical coupling element that includes a wafer, an array of micro-lenses fabricated at one side of a wafer, and an array of discrete micro-prisms fabricated at another side of the wafer, wherein the array of micro-lenses is integrated with corresponding array of micro-prisms, such that each micro-prism is positioned directly in-line or aligned over corresponding micro-lens, wherein each micro-prism is configured to rotate an input optical beam by up to 90 degrees, and corresponding micro-lens is configured to expand and collimate the rotated beam, to form a pluggable optical connector.

In an embodiment of the present invention, each micro-prism is configured to rotate the input optical beam by 90 degrees.

In an embodiment of the present invention, a spin on polymer layer is provided at the another side of the wafer to enable printing of the array of micro-prisms on the spin on polymer layer using nano-imprint technology.

In an embodiment of the present invention, the array of micro-prisms is printed en-mass across the wafer with sub-micron precision.

In an embodiment of the present invention, the spin-on polymer layer has a printable material and is spin-coated to the required thickness with a thin metal to achieve high reflectivity.

In an embodiment of the present invention, the wafer is one of: clear optical glass or a silicon wafer for infra-red applications.

In an embodiment of the present invention, the array of micro-lens is fabricated at a wafer-level using conventional photolithography and etching techniques.

In an embodiment of the present invention, the micro-optical coupling element further comprises one or more internal waveguides fabricated using laser writing or ion diffusion.

In an embodiment of the present invention, there is provided a photonic integrated circuit (PIC) that includes a top surface including a plurality of interleaved waveguides, and a plurality of etched cavities at ends of corresponding plurality of interleaved waveguides, wherein the plurality of etched cavities is configured to receive and bond with corresponding plurality of micro-prisms of the micro-optical coupling element.

In an embodiment of the present invention, the micro-optical coupling element is bonded to the top surface using soldering.

In an embodiment of the present invention, the micro-optical coupling element enables surface coupling of the photonic integrated circuit with one or more external optical components by rotating the input optical beam from the plurality of interleaved waveguides by 90 degrees, and expanding and collimated the rotated beam.

In another aspect of the present invention, there is further provided a photonic integrated circuit (PIC), that includes a top surface including a plurality of PIC waveguides, wherein each internal waveguide of a micro-optical coupling element is positioned and packaged over corresponding PIC waveguide to enable evanescence coupling of the PIC and the micro-optical coupling element, with out-of-plane beam collimation.

In an embodiment of the present invention, the PIC and the micro-optical coupler are assembled on a printed circuit board (PCB) for enabling connection with a pluggable fibre connector, and wherein the micro-optical coupler has one or more alignment markers for aligning with a pluggable fibre connector base bonded on to the PCB, and wherein the pluggable fibre connector base has a plurality of guide holes to receive corresponding plurality of pins of the pluggable fibre connector.

In an embodiment of the present invention, the PIC and the micro-optical coupler are bonded using one or more metal bumps, with a height of an order of 1-2 microns.

In an embodiment of the present invention, there is provided a photonic integrated circuit (PIC) that includes a top surface including a plurality of PIC waveguides, wherein each internal waveguide of a plurality of micro-optical coupling elements, is positioned and packaged over corresponding PIC waveguide to enable evanescence coupling of the PIC and the plurality of micro-optical coupling elements, with out-of-plane beam collimation, wherein the PIC and the plurality of micro-optical coupler elements are assembled on a printed circuit board (PCB) for enabling connection with a plurality of pluggable fibre connectors to form a plurality of pluggable zones, and wherein the plurality of pluggable zones form a fan-out optical waveguide structure.

In one embodiment at least one micro-prism is configured to rotate the input optical beam by up to 180 degrees.

Various embodiments of the present invention provide a micro-optical coupler and a method to fabricate and bond the micro-optical coupler to the PIC chip to enable surface coupling in PICs. The surface coupling enables more optical channels to be connected to a PIC in a 2D form. Also, the surface coupling enables faster packaging times due to the improved machine vision performance, as the packaging machine can see the PIC surface easier than the PIC edge. Further, the surface coupling enables replacement of unstable optical epoxies or resins with solders which can be bonded on to the surface of the PIC chip similar to the conventional electronic packaging processes. Thus, due to the improved optical performance and significantly improved (faster) packaging process, the surface coupling is highly attractive for performance and manufacturing reasons.

### BRIEF DESCRIPTION OF DRAWINGS

The invention will be more clearly understood from the following description of an embodiment thereof, given by way of example only, with reference to the accompanying drawings, in which:—

FIG. 1 illustrates conventional packaging of optical fibres to a PIC chip;

FIG. 2 illustrates using micro-optics to achieve the pluggability, where a micro-lens may be bonded to the PIC chip and an expanded and collimated beam may be formed;

FIG. 3 illustrates an air gap formed by the collimated beam between the fibre used for the pluggable connector;

FIG. 4A illustrates the schematic showing a process sequence to form a micro-optical coupler, using nano imprint technology, in accordance with an embodiment of the present invention;

FIG. 4B illustrates a side view schematic showing the micro-optical coupler assembled in a PIC chip to achieve surface emission and a pluggable optical connector;

FIG. 5A illustrates a micro-optical coupler for enabling surface coupling of a PIC waveguide with other optical components (not shown), in accordance with an embodiment of the present invention;

FIG. 5B illustrates surface coupling using the micro-optical coupler which re-directs an edge optical beam by 90 degrees, in accordance with an embodiment of the present invention;

FIG. 6A illustrates evanescence coupling between a PIC and a micro-optical coupler, in accordance with an embodiment of the present invention;

FIG. 6B illustrates a side view of the optical coupling scheme showing the metal pump bonds used to precisely fix the distance between the photonic waveguide, and optical imposer;

FIGS. 7A and 7B illustrates front and top views of bonding of a pluggable fibre connector with respect to the PIC and micro-optical coupler of FIG. 6 respectively, in accordance with an embodiment of the present invention;

FIGS. 8A and 8B illustrate front and top views of coupling of the micro-optical coupler with the pluggable connector to form a single pluggable zone, in accordance with an embodiment of the present invention; and

FIGS. 9A and 9B illustrate front and top views of coupling of a plurality of micro-optical couplers with corresponding plurality of pluggable connectors to form a plurality of pluggable zones, in accordance with an embodiment of the present invention.

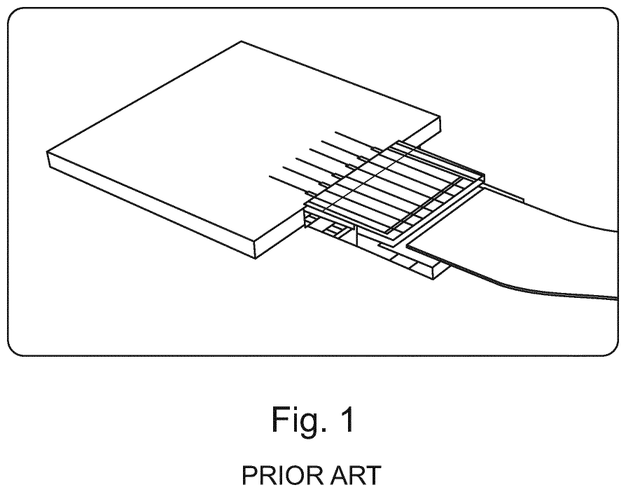

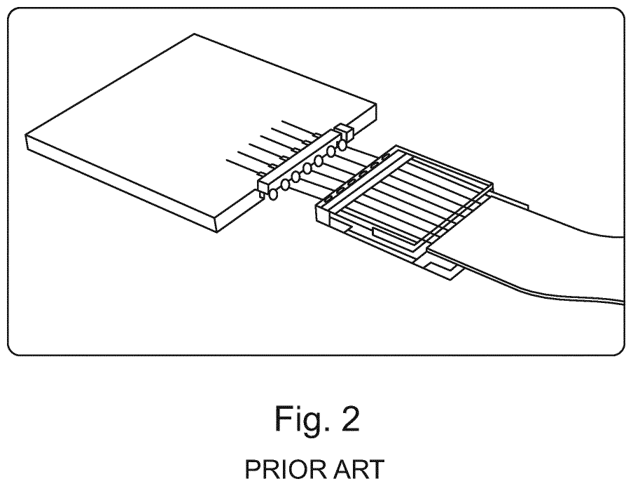

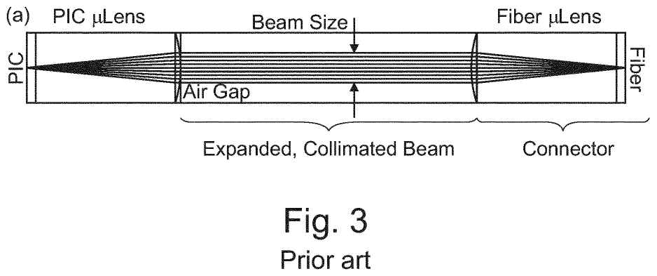

### DETAILED DESCRIPTION OF THE DRAWINGS

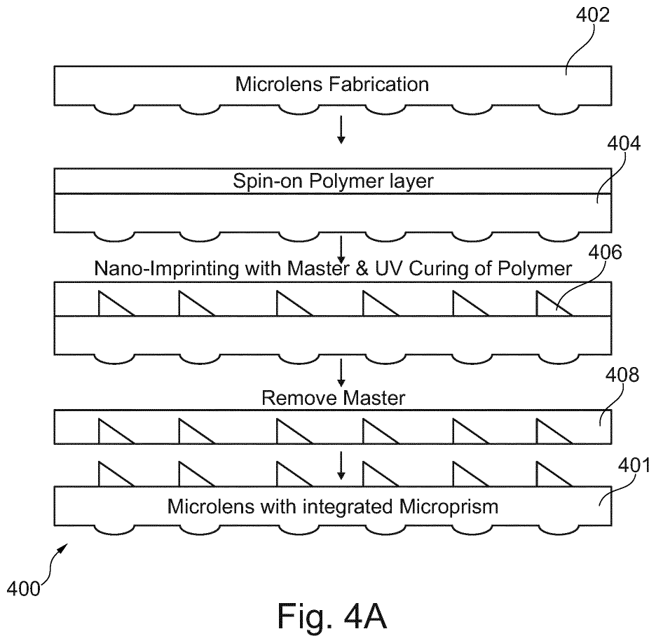

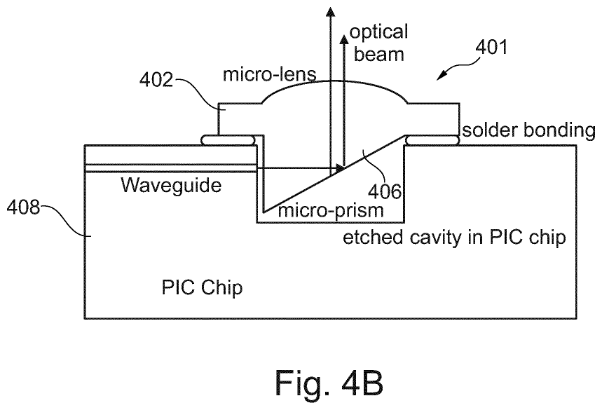

FIG. 4A illustrates the schematic showing a process sequence 400 to form a micro-optical coupler 401, using nano imprint technology, in accordance with an embodiment of the present invention. The micro-optical coupler 401 includes an array of micro-lenses with an integrated array of micro-prisms.

Firstly, an array of micro-lens 402 may be fabricated at a wafer-level using conventional photolithography and etching techniques. This may be performed at one side of the wafer, where the wafer can be clear optical glass or a silicon wafer for infra-red applications. Then, a spin-on polymer layer 404 may be provided at a back side of the array of micro-lenses 402. The spin-on polymer 404 has a print material and can be spin-coated to the required thickness. The spin-on polymer 404 can also be coated with a thin metal (e.g. Au or Al) to achieve high reflectivity. Thereafter, an array of discrete micro-prisms 406 may be printed simultaneously and positioned directly in-line or aligned over corresponding micro-lens 402 at the backside of the wafer using nano-imprint technology. The array of micro-prisms 406 may be printed en-mass across the wafer with sub-micron precision. The benefit of this approach is the significantly reduced expansion and contraction experienced by the polymer micro-prism during the solder reflow process. The replication master 408 is then removed to form the micro-optical component 400 including an array of micro lenses integrated with corresponding array of microprisms.

It is to be noted that the typical dimensions for this integrated micro-optical coupler 400 are on the order of 10 to 100 microns, depending on the specific details of the PIC chip and overall optical design.

FIG. 4B illustrates a side view schematic showing the micro-optical coupler 401 including an integrated micro-prism 406 and corresponding micro-lens 402 assembled in a PIC chip 408 to achieve surface emission and a pluggable optical connector. The micro-optical coupler 401 may be bonded to the surface of the PIC chip 408 using solder rather than epoxy. An example of the solder is AuSn solder. The PIC chip 408 includes an etched cavity for receiving the micro-prism 406. As shown, the micro-prism 406 rotates an edge optical beam by an angle ranging from −45 to +45 degrees for surface emission, and the micro-lens 402 expand and collimate the beam to enable a pluggable connector. Preferably, the edge optical beam is rotated by up to 90 degrees.

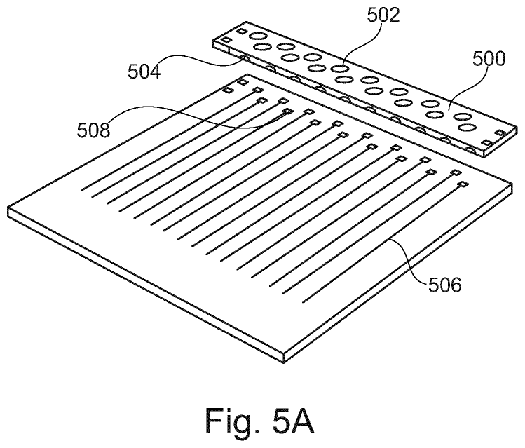

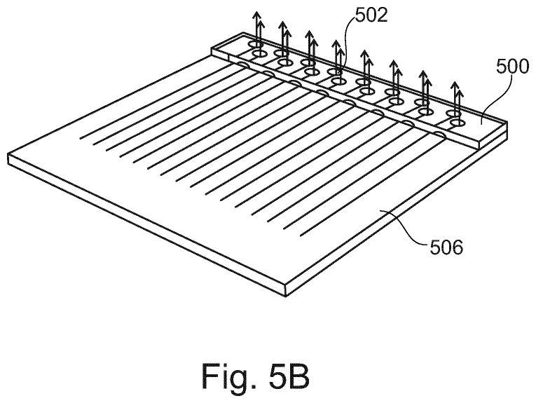

FIG. 5A illustrates a micro-optical coupler 500 (similar to the micro-optical coupler 401) for enabling surface coupling of a PIC waveguide 506 with other optical components (not shown), in accordance with an embodiment of the present invention. The micro-optical component 500 is formed of an array of micro-lenses 502 at its top surface, and an array of micro-prisms 506 at its bottom surface. The PIC 506 may include etched cavities for receiving the array of micro-prisms 506.

In an embodiment of the present invention, the bottom surface of the micro-optical component 500 may be soldered with the top surface of the PIC waveguide 506. In an embodiment of the present invention, the waveguides in the PIC 506 may be interleaved to minimise the waveguide pitch or spacing.

FIG. 5B illustrates surface coupling using the micro-optical coupler 500 which re-directs an edge optical beam by up to 90 degrees. The array of micro-prisms 504 (not shown herein) rotate an input optical beam by up to 90 degrees, and the array of micro-lenses 502 expand and collimate the rotated beam.

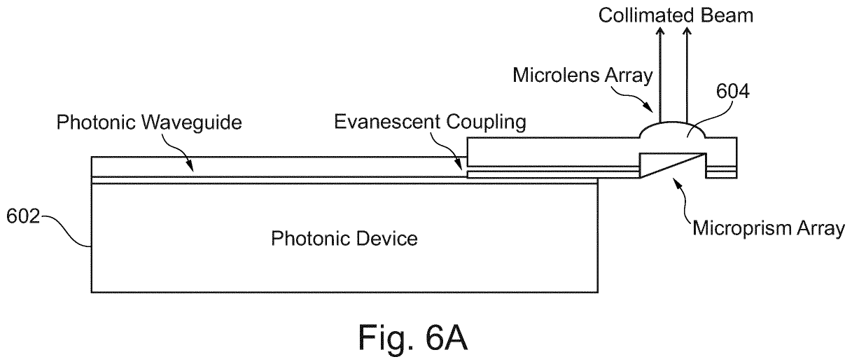

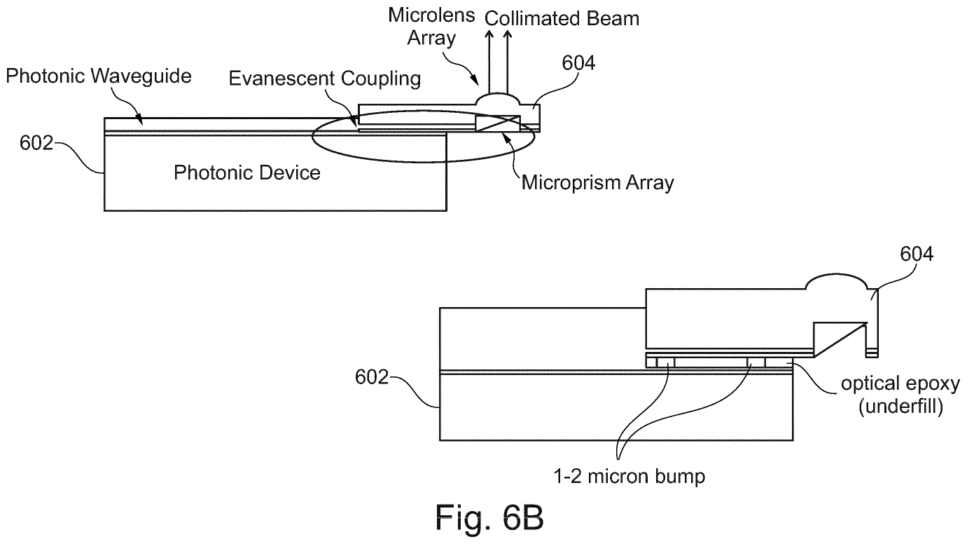

FIG. 6A illustrates evanescence coupling between a PIC 602 and a micro-optical coupler 604, in accordance with an embodiment of the present invention. In this form, the PIC waveguide is exposed (e.g. etching of the semiconductor surface). The micro-optical coupler 604 has its own internal waveguide, and is packaged over the waveguide of the PIC 602. By taking account of the required distance between waveguides of both the PIC 602 and the micro-optical coupler 604, the optical field can be efficiently coupled between both elements. The PIC 602 and the micro-optical coupler 604 can be bonded using materials such as polymers, which can be deposited on the PIC 602 to the required thickness. Critically, the micro-optical coupler 604 incorporates a micro prism and micro lens which are used for out-of-plane beam collimation. This enables the pluggable connector design, as shown in the previous embodiments. The micro-optical coupler 604 can be made of glass with internal waveguides fabricated using laser writing or ion diffusion. The glass element can include etched holes which can be used to precisely align and fix the receiving pluggable connector (where the pluggable connector has alignment pins in its assembly). The micro-optical coupler 604 (prism and lens) can be produced using the nanoimprint lithographic process, as previously described with reference to FIG. 4A. It is to be noted that the general principle of evanescence coupling is well-known. However, photonic chips are usually not manufactured such that the evanescence technique can be used. The present invention employs evanescence coupling using a specially designed optical coupling component.

FIG. 6B illustrates a side view of the optical coupling scheme showing the metal pump bonds used to precisely fix the distance between the photonic waveguide 602, and the optical coupler 604. The gap can be filled with on index matching material such as an optical epoxy or clear silicone rubber. The distance or gap between the optical coupler 604 and the photonic chip 602 must be set at an optimum distance or gap to achieve maximum optical between corresponding photonic and coupler waveguides. This gap is usually on the order of 1-2 microns. Furthermore, the gap is usually filled with an index matching material such as an optical epoxy or clear silicone rubber (typical refractive index value of 1.5). To ensure the gap is precise and across a large area, the photonic device and glass optical coupler can be bonded using metal bumps, with a height of the order of 1-2 microns.

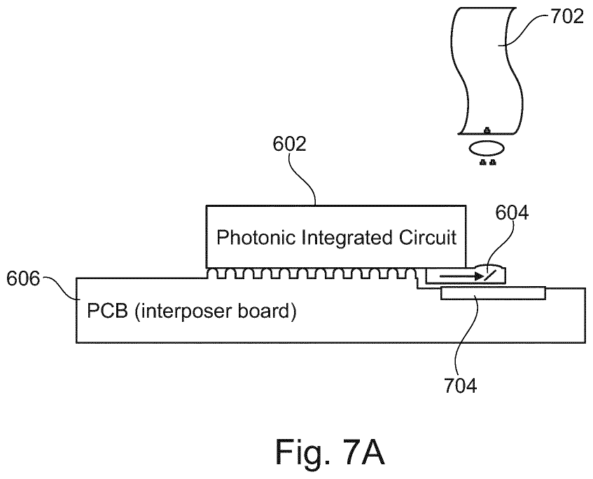

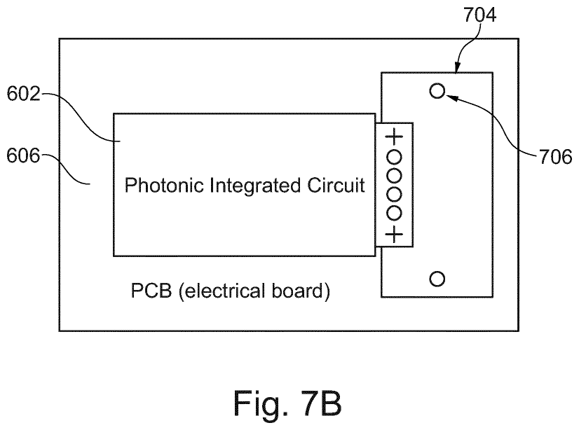

FIGS. 7A and 7B illustrates front and top views of bonding of a pluggable fibre connector 702 with respect to the PIC 602 and micro-optical coupler 604 of FIG. 6 respectively, in accordance with an embodiment of the present invention.

The micro-optical coupler 604 can be assembled on a board, such as a PCB or other electrical carrier 606, enabling it to be connected to a pluggable fibre receiver component. The micro-optical coupler 604 may be flip chip mounted on a PCB electrical board 606. The pluggable fibre connector 702 may be assembled on to the PCB electrical board 606 such that it is capable of collecting the expended and collimated beam emitted from the micro-optical coupler 604, and re-focusing the beam into an optical fibre. The pluggable fibre connector base 704 (snap fit base for top part) may be bonded on to the PCB 606 such that is precisely aligned with respect to the micro-optical coupler 604. To achieve this, one or more alignment markers may be included on the micro-optical coupler 604 to guide bonding of the base 704. The bonding of the base 704 may be achieved using epoxy or solder bonding. The base 704 also has guide holes 706 for engaging with the top receiving part of the connector 702 which has pins to fit into these holes. This precise alignment between the micro-optical coupler 604 and the pluggable connector 702 ensures the collimated beam is re-focused into the collector optical fibre with high coupling efficiency.

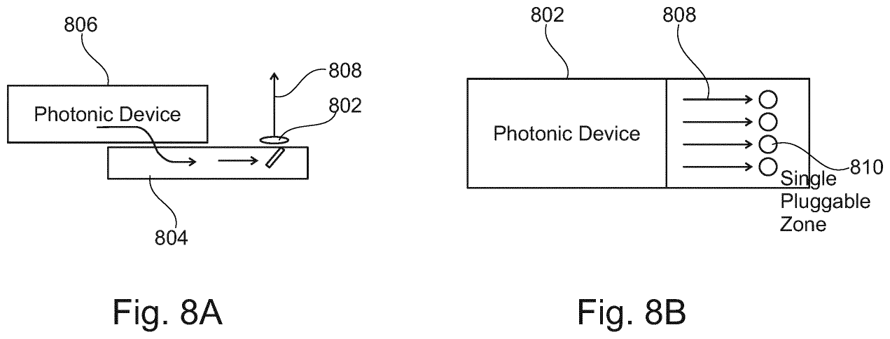

FIGS. 8A and 8B illustrate front and top views of coupling of the micro-optical coupler 802 with the pluggable connector to form a single pluggable zone. The micro-optical coupler 802 can be assembled on a board, such as a PCB or other electrical carrier 804. The micro-optical coupler 802 rotates the input beam from the photonic device 806 by 90 degrees, and generates a collimated light output 808. The collimated light output 808 may be collected by the pluggable connector that includes a single array of emitters 810. The single array of emitters 810 may form a single pluggable zone.

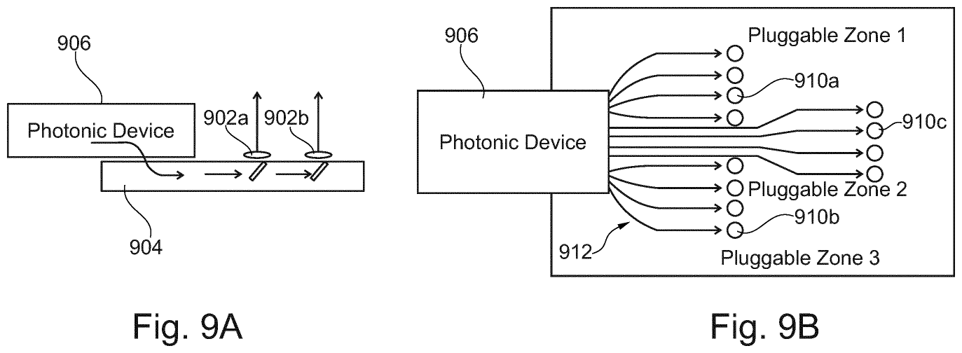

FIGS. 9A and 9B illustrate front and top views of coupling of a plurality of micro-optical couplers 902a and 902b with corresponding plurality of pluggable connectors to form a plurality of pluggable zones. The micro-optical couplers 902a and 902b can be assembled on a board, such as a PCB or other electrical carrier 904. The micro-optical couplers 902a and 902b may rotate the input beam from the photonic device 906 by up to 90 degrees, and generates respective collimated light outputs. The collimated light outputs may be collected by multiple pluggable connectors. In this example, the collimated light outputs are collected by three arrays of emitters 910a, 910b and 910c, thus forming three pluggable zones. The multiple pluggable zones forms a fan-out optical waveguide structure 912 that enables a much higher number of optical waveguides into the photonic device 906. Any number of pluggable zones can be used to enable a large number of pluggable connecters to be used. Each pluggable zone can be allocated its individual and smaller pluggable connector. This is desirable as it is difficult and expensive to produce a large area connector using processes such as micro injection moulding due to mechanical stress, warpage and shrinkage arising during the thermal moulding process.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. a memory stick or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. A micro-optical coupling element, comprising:
a wafer;
an array of micro-lenses fabricated at one side of the wafer; and
an array of discrete micro-prisms fabricated at another side of the wafer, wherein the array of micro-lenses is integrated with a corresponding array of micro-prisms, such that each micro-prism is positioned directly in-line or aligned over a corresponding micro-lens, wherein each micro-prism is configured to rotate an input optical beam by up to 90 degrees, and the corresponding micro-lens is configured to expand and collimate the rotated beam, to form a pluggable optical connector.

2. The micro-optical coupling element as claimed in claim 1 wherein each micro-prism is configured to rotate the input optical beam by 90 degrees.

3. The micro-optical coupling element as claimed in claim 1, wherein a spin on polymer layer is provided at the another side of the wafer to enable printing of the array of micro-prisms on the spin on polymer layer using nano-imprint technology.

4. The micro-optical coupling element as claimed in claim 3, wherein the array of micro-prisms is printed en-mass across the wafer with sub-micron precision.

5. The micro-optical coupling element as claimed in any preceding claim, wherein the spin-on polymer layer has a printable material and is spin-coated to the required thickness with a thin metal to achieve high reflectivity.

6. The micro-optical coupling element as claimed in any preceding claim, wherein the wafer is one of: clear optical glass or a silicon wafer for infra-red applications.

7. The micro-optical coupling element as claimed in any preceding claim, wherein the array of micro-lens is fabricated at a wafer-level using conventional photolithography and etching techniques.

8. The micro-optical coupling element as claimed in any preceding claim further comprising one or more internal waveguides fabricated using laser writing or ion diffusion.

9. A photonic integrated circuit (PIC), comprising:
a top surface including a plurality of interleaved waveguides; and
a plurality of etched cavities at ends of corresponding plurality of interleaved waveguides, wherein the plurality of etched cavities is configured to receive and bond with a corresponding plurality of micro-prisms of the micro-optical coupling element claimed in any one of claims 1-8.

10. The photonic integrated circuit as claimed in claim 9, wherein the micro-optical coupling element is bonded to the top surface using soldering.

11. The photonic integrated circuit as claimed in claims 9 or 10, wherein the micro-optical coupling element enables surface coupling of the photonic integrated circuit with one or more external optical components by rotating the input optical beam from the plurality of interleaved waveguides by up to 90 degrees, and expanding and collimated the rotated beam.

12. A photonic integrated circuit (PIC), comprising:
a top surface including a plurality of PIC waveguides, wherein each internal waveguide of a micro-optical coupling element as claimed in any one of claims 1-8 is positioned and packaged over corresponding PIC waveguide to enable evanescence coupling of the PIC and the micro-optical coupling element, with out-of-plane beam collimation.

13. The PIC as claimed in claim 12, wherein the PIC and the micro-optical coupler are assembled on a printed circuit board (PCB) for enabling connection with a pluggable fibre connector to form a single pluggable zone, and wherein the micro-optical coupler has one or more alignment markers for aligning with a pluggable fibre connector base bonded on to the PCB, and wherein the pluggable fibre connector base has a plurality of guide holes to receive corresponding plurality of pins of the pluggable fibre connector.

14. The PIC as claimed in claims 12 or 13, wherein the PIC and the micro-optical coupler are bonded using one or more metal bumps, with a height of an order of 1-2 microns.

15. A photonic integrated circuit (PIC), comprising:
a top surface including a plurality of PIC waveguides, wherein each internal waveguide of a plurality of micro-optical coupling elements, as claimed in any one of claims 1-8 is positioned and packaged over corresponding PIC waveguide to enable evanescence coupling of the PIC and the plurality of micro-optical coupling elements, with out-of-plane beam collimation, wherein the PIC and the plurality of micro-optical coupler elements are assembled on a printed circuit board (PCB) for enabling connection with a plurality of pluggable fibre connectors to form a plurality of pluggable zones, and wherein the plurality of pluggable zones form a fan-out optical waveguide structure.
